(19) United States
(12) Patent Application Publication
(10) Pub. No.: US 2006/0181185 A1
(43) Pub. Date: Aug. 17, 2006

(54) Spark plug having shield for ground electrode

(75) Inventors: Koji Yamanaka, Kariya-shi (JP); Tetsuya Watanabe, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/352,353

(22) Filed: Feb. 13, 2006

(30) Foreign Application Priority Data
Feb. 16, 2005 (JP) 2005-039463

(51) Int. Cl. H01T 13/34

(52) U.S. Cl. 313/144

(57) ABSTRACT

A spark plug according to the present invention includes a tubular metal shell, an insulator, a center electrode, a ground electrode, and a shield. The insulator is retained in the metal shell. The center electrode is secured in the insulator such that an end portion of the center electrode protrudes out of the insulator. The ground electrode includes a base portion, a tip portion, and a joining portion that joins together the base and tip portions. The base portion is fixed to the metal shell. The tip portion faces the side surface of the end portion of the center electrode through a spark gap in a direction perpendicular to the longitudinal direction of the spark plug. The shield shields the joining portion of the ground electrode from directly facing outside of the spark plug in the longitudinal direction of the spark plug, thereby securing the reliability of the joining portion.

### CROSS-REFERENCE TO RELATED APPLICATION

This application is based on and claims priority from Japanese Patent Application No. 2005-39463, filed on Feb. 16, 2005, the content of which is hereby incorporated by reference into this application.

### BACKGROUND OF THE INVENTION

1. Technical Field of the Invention

The present invention relates generally to spark plugs for use in internal combustion engines of automotive vehicles and cogeneration systems.

More particularly, the invention relates to a spark plug for an internal combustion engine, in which a shield is provided to secure a reliable joining of two different parts of a ground electrode.

2. Description of the Related Art

FIG. 18 shows an existing spark plug 9 for use in an internal combustion engine, for example, of a cogeneration system. As shown in the figure, the spark plug 9 includes a center electrode 91, a ground electrode 92, an insulator 93, and a tubular metal shell 94.

The center electrode 91 is secured in the insulator 93 and has an end portion 911 that protrudes out of the insulator 93. The insulator 93 is retained in the tubular meal shell 94. The ground electrode 92 includes a base portion 921, a tip portion 922, and a joining portion 923 that joins together the base and tip portions 921 and 922. The base portion 921 is fixed to the metal shell 94. The tip portion 922 faces the side surface of the end portion 911 of the center electrode 91 in the radial direction of the spark plug 9. The base portion 921 and the tip portion 922 are made of different materials and joined together by welding, so that a weld is formed therebetween as the joining portion 923. (With regard to such a spark plug, a reference can be made to Japanese Patent First Publication No. 2002-83662, whose English equivalent is U.S. Pat. No. 6,724,132.)

Upon installation of the spark plug 9 in the engine, the joining portion 923 of the ground electrode 92 is located in a combustion chamber of the engine and thus exposed to the combustion gases in the combustion chamber. Consequently, the joining portion 923, which has a lower strength than both the base and tip portions 921 and 922, may be easily oxidized.

Moreover, to meet recent requirements of high engine efficiency and low engine emission, both the flow speed and temperature of the air/fuel mixture within the combustion chamber of the engine have increased, thus making it easy for the joining portion 923 of the ground electrode 92 to crack or vaporize due to oxidization. Consequently, it becomes difficult to secure a reliable joining of the tip portion 922 to the base portion 921, and thus the tip portion 922 can be easily separated from the base portion 921.

Furthermore, in the case of the engine being employed in a cogeneration system, heat load will be imposed on the joining portion 923 of the ground electrode 92 for a long time period, thus making it further difficult to secure a reliable joining of the tip portion 922 to the base portion 921.

### SUMMARY OF THE INVENTION

It is, therefore, an object of the present invention to overcome the above-mentioned problem encountered with the existing spark plugs.

It is another object of the present invention to provide a spark plug for an internal combustion engine, which has an improved structure ensuring a reliable joining of two different parts of a ground electrode.

According to the present invention, a spark plug is provided which includes a tubular metal shell, an insulator, a center electrode, a ground electrode, and a shield.

The insulator is retained in the metal shell. The center electrode is secured in the insulator such that an end portion of the center electrode protrudes out of the insulator. The ground electrode includes a base portion, a tip portion, and a joining portion that joins together the base and tip portions. The base portion is fixed to the metal shell. The tip portion faces the side surface of the end portion of the center electrode through a spark gap in a direction perpendicular to the longitudinal direction of the spark plug. The shield shields the joining portion of the ground electrode from directly facing outside of the spark plug in the longitudinal direction of the spark plug.

In a preferred mode of the present invention, the shield is so formed to have at least a portion thereof extending in the direction perpendicular to the longitudinal direction of the spark plug, by which the joining portion of the ground electrode is completely shielded from directly facing outside of the spark plug in the longitudinal direction of the spark plug.

The tip portion of the ground electrode is closer to the end portion of the center electrode in the direction perpendicular to the longitudinal direction of the spark plug than the shield 0.3 mm or more.

The distance between the shield and the tip portion of the ground electrode in the longitudinal direction of the spark plug is 2 mm or less.

The shield may be integrally formed with the metal shell. Specifically, the metal shell may have an inner chamber, in which the ground electrode is mounted, and an end portion that serves as the shield. In this case, a slit may be preferably formed in the end portion of the metal shell without having the same angular position as the joining portion of the ground electrode. The slip may preferably have a width in the range of 1 to 2 mm.

Else, the shield and the ground electrode may be separately formed and fixed to the metal shell.

Else, the shield may be integrally formed with the ground electrode. In this case, the tip portion of the ground electrode may serve as the shield. Instead, the base portion of the ground electrode may serve as the shield with the base portion, joining portion, and tip portion of the ground electrode being serially arranged in the direction perpendicular to the longitudinal direction of the spark plug. Otherwise, the base portion of the ground electrode may serve as the shield with the base portion, joining portion, and tip portion of the ground electrode being serially arranged in the longitudinal direction of the spark plug.

The shield is preferably made of one of a Ni-based alloy and steel.

In another preferred embodiment of the present invention, the shield is composed of a coating layer that covers the surface of the joining portion of the ground electrode.

It is preferable that the coating layer covers the surface of the joining portion of the ground electrode over the entire circumference thereof. It is also preferable that the coating layer is made of a ceramic material.

Moreover, the spark plug according to the present invention may be configured to further include a plurality of the ground electrodes, wherein the joining portions of all the ground electrodes are shielded by the single shield. Otherwise, the spark plug may also be configured to include a plurality of the ground electrodes and a plurality of the shields, wherein the joining portion of each of all the ground electrodes is shielded by a corresponding one of all the shields.

In the spark plug according to the present invention, the tip portion of the ground electrode is preferably made of one of an Ir-based alloy and a Pt-based alloy.

In the spark plug according to the present invention, the base portion of the ground electrode is preferably made of one of a Ni-based alloy and steel.

In the spark plug according to the present invention, the joining portion of the ground electrode may be a weld formed by laser welding of the tip portion to the base portion of the ground electrode. Otherwise, the joining portion of the ground electrode may be a weld formed by resistance welding of the tip portion to the base portion of the ground electrode.

In the spark plug according to the present invention, the end portion of the center electrode may have a prismatic shape and the tip portion of the ground electrode may have a flat end face facing the side surface of the end portion of the center electrode through the spark gap. Otherwise, the end portion of the center electrode may have a cylindrical shape and the tip portion of the ground electrode may have an end face that is recessed outwardly along the side surface of the end portion of the center electrode with the spark gap formed therebetween.

Consequently, through providing the above spark plug, the objects of the present invention are achieved.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross-sectional side view showing an end portion of a spark plug according to the first embodiment of the invention;

FIG. 2 is an end view, partially in cross-section, of the spark plug of FIG. 1;

FIG. 3 is a partially cross-sectional side view showing the spark plug of FIG. 1 being installed in a combustion chamber of an internal combustion engine;

FIG. 4 is a schematic view illustrating key parameters in the spark plug of FIG. 1;

FIG. 5 is a graphical representation showing the relationship between a distance A and the strength of a joining portion of a ground electrode in the spark plug of FIG. 1;

FIG. 6 is a graphical representation showing the relationship between a slit width S and the ignition capability of the spark plug of FIG. 1;

FIG. 7 is a graphical representation showing the relationship between a distance W and the strength of the joining portion of the ground electrode in the spark plug of FIG. 1;

FIG. 8 is an end view, partially in cross-section, showing a park plug according to the second embodiment of the invention;

FIG. 9 is an end view, partially in cross-section, showing a park plug according to the third embodiment of the invention;

FIG. 10 is an end view, partially in cross-section, showing a park plug according to the fourth embodiment of the invention;

FIG. 11 is an end view, partially in cross-section, showing a park plug according to the fifth embodiment of the invention;

FIG. 12 is a partially cross-sectional side view showing an end portion of a spark plug according to the sixth embodiment of the invention;

FIG. 13 is a partially cross-sectional side view showing an end portion of a spark plug according to the seventh embodiment of the invention;

FIG. 14 is a partially cross-sectional side view showing an end portion of a spark plug according to the eighth embodiment of the invention;

FIG. 15 is a partially cross-sectional side view showing an end portion of a spark plug according to the ninth embodiment of the invention;

FIG. 16 is a partially cross-sectional side view showing an end portion of a spark plug according to the tenth embodiment of the invention;

FIG. 17 is a schematic view illustrating a joining portion of a ground electrode of a spark plug according to the eleventh embodiment of the invention; and

FIG. 18 is a partially cross-sectional side view showing an end portion of a prior art spark plug.

### DESCRIPTION OF THE PREFERRED EMBODIMENTS

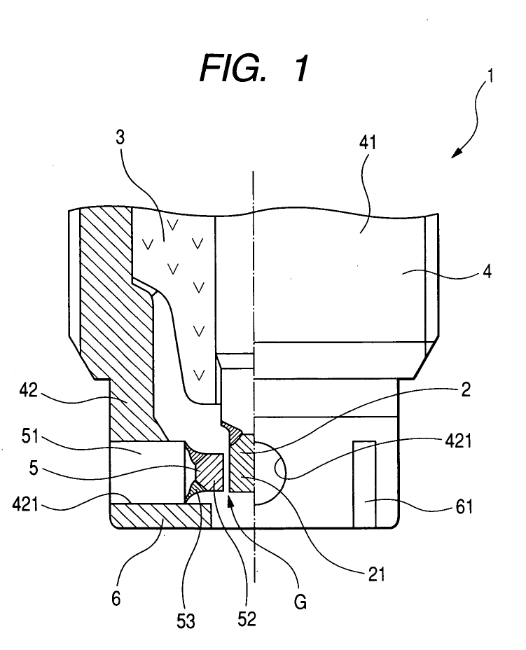

The preferred embodiments of the present invention will be described hereinafter with reference to FIGS. 1-17.

It should be noted that, for the sake of clarity and understanding, identical components having identical functions in different embodiments of the invention have been marked, where possible, with the same reference numerals in each of the figures.

### First Embodiment

FIGS. 1-3 show the overall structure of a spark plug 1 according to the first embodiment of the invention.

The spark plug 1 is designed for use in an internal combustion engine, for example, of an automotive vehicle or a cogeneration system. Specifically, the spark plug 1 is designed to ignite the air/fuel mixture within a combustion chamber of the engine.

As shown in the figures, the spark plug 1 includes a center electrode 2, an insulator 3, a tubular metal shell 4, and four ground electrodes 5.

The tubular metal shell 4 has a male threaded portion 41 on an outer periphery thereof, through which the spark plug 1 is installed in the combustion chamber of the engine. The metal shell 4 is made of a conductive metal material, such a Ni-based alloy and steel.

The insulator 3 is retained in the metal shell 4. The insulator 3 is made, for example, of alumina (Al₂O₃).

The center electrode 2 is secured in the insulator 3, so that it is electrically isolated from the metal shell 4. The center electrode 2 has an end portion 21 that protrudes out of the insulator 3. In the present embodiment, the end portion 21 has a cuboid shape and accordingly four side faces.

The center electrode 2 may be made of a highly heat conductive metal material such as Cu as the core material and a highly heat-resistant, corrosion-resistant metal material such as a Ni (Nickel)-based alloy as the cladding material. Moreover, the end portion 21 of the center electrode 2 may be composed of a noble metal chip that is made, for example, of an Ir-based alloy or a Pt-based alloy.

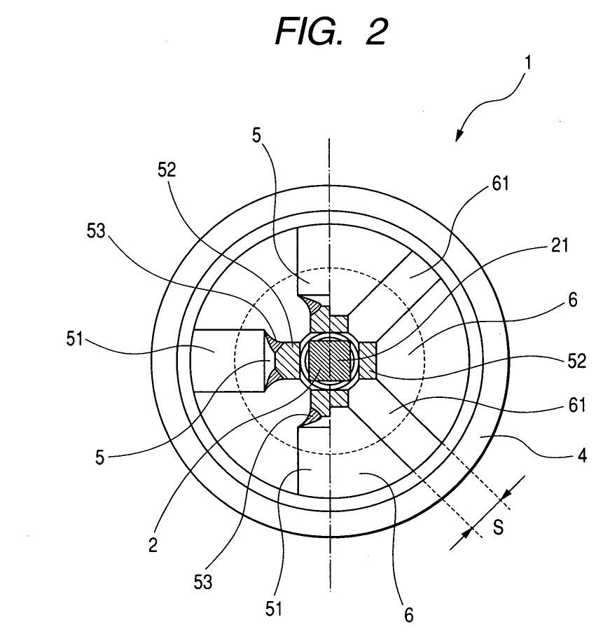

The four ground electrodes 5 are, as shown in FIG. 2, spaced evenly circumferentially around the center electrode 2.

Each of the ground electrodes 5 has a base portion 51, a tip portion 52, and a joining portion 53 that joins together the base and tip portions 51 and 53.

The base portion 51 is made, for example, of a Ni-based alloy or steel. The base portion 51 is fixed to the metal shell 4, so that it is electrically connected to the metal shell 4.

The tip portion 52 is made of a noble metal material, such as an Ir-based alloy and a Pt-based alloy. The tip portion 52 faces a corresponding one of the four side faces of the end portion 21 of the center electrode 2 through a spark gap G in the radial direction of the spark plug 1.

The base portion 51 and the tip portion 52, which are made of different materials as described above, are joined together by, for example, laser welding, so that a weld is formed therebetween as the joining portion 53. The joining portion 53 has a lower strength than both the base and tip portions 51 and 52 and may be damaged when directly exposed to the high-speed and high-temperature combustion gases in the combustion chamber.

To protect the joining portion 53, there is provided a shield 6 in the spark plug 1. The shield 6 is so formed, as shown in FIG. 1, to extend in the radial direction of the spark plug 1 to shield the joining portion 53 of the ground electrode 5 from directly facing outside of the spark plug 1 in the axial direction of the spark plug 1.

In the present embodiment, the shield 6 is integrally formed with the metal shell 4. Specifically, as shown in FIG. 1, the metal shell 4 has an extension portion 42 that extends in the axial direction of the spark plug 1 from the threaded portion 41 beyond the insulator 2. The extension portion 42 has four inner chambers 421, in which the four ground electrodes 5 are respectively mounted, and an end portion 6 that serves as the shield 6.

Further, the extension portion 42 of the metal shell 4 has four slits 61, each of which is formed at the circumferentially intermediate position between two adjacent inner chambers 421. In other words, all the slits 61 have an angular position different from those of the joining portions 53 of the ground electrodes 5, so that all the joining portions 53 of the ground electrodes 5 are kept from directly facing outside of the spark plug 1 in the axial direction of the spark plug 1.

With such a formation of slits 61, the end portion 6 of the extension portion 42 of the metal shell 4 can be considered as being divided into four separate shields 6, each of which shields the joining portion 53 of a corresponding one of the four ground electrodes 4.

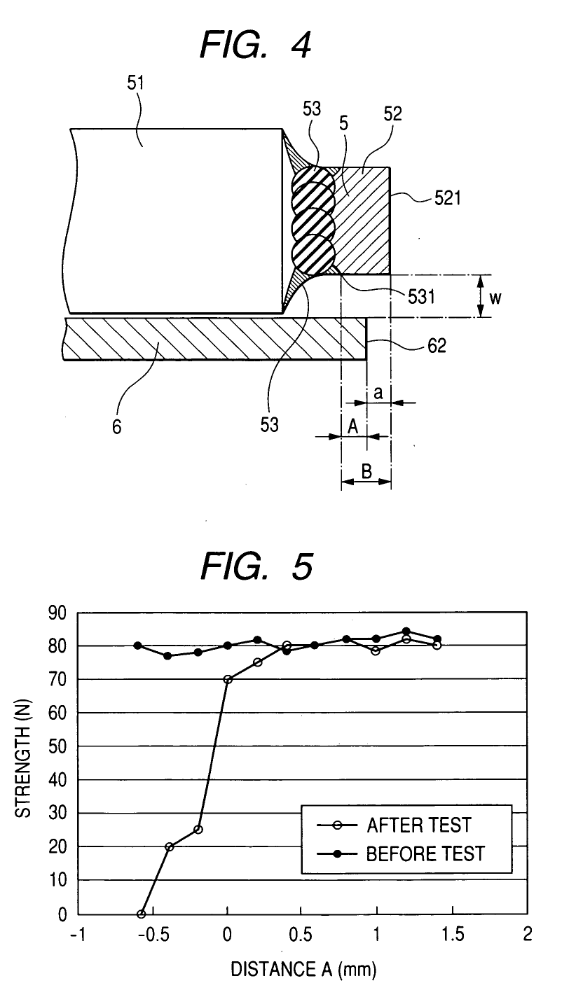

Having described the overall structure of the spark plug 1, the following dimensional parameters are specified in the spark plug 1 with reference to FIGS. 4 and 2.

The distance A between the inner end face 62 of each of the shields 6 and the inner end 531 of the joining portion 53 of a corresponding one of the ground electrodes 5 in the radial direction of the spark plug 1 is greater than or equal to zero.

The distance a between the inner end face 521 of the tip portion 52 of each of the ground electrodes 5 and the inner end face 62 of a corresponding one of the shields 6 in the radial direction of the spark plug 1 is greater than or equal to 0.3 mm.

The distance W between the tip portion 52 of each of the ground electrodes 5 and a corresponding one of the shields 6 in the axial direction of the spark plug 1 is less than or equal to 2 mm.

The width S of each of the slits 61 is in the range of 1 to 2 mm.

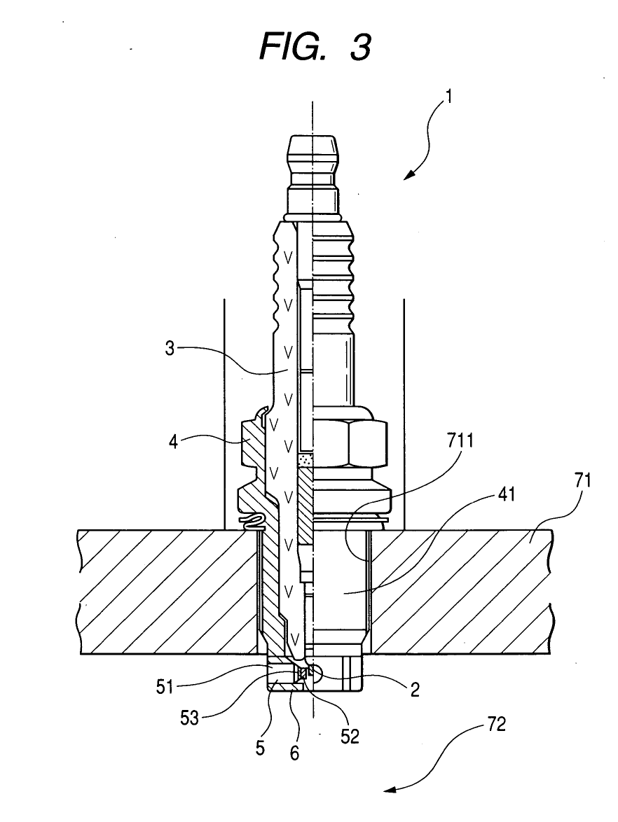

The above-described spark plug 1 is, as shown in FIG. 3, installed in the combustion chamber 72 of the engine through the engagement between the threaded portion 41 of the metal shell 4 and a threaded bore 711 formed in a cylinder head 71 of the engine. Consequently, the end portion 21 of the center electrode 2 and the ground electrodes 5 are located in the combustion chamber 72, so as to discharge sparks therebetween within the combustion chamber 72.

The spark plug 1 according to the present embodiment has the following advantages.

In the spark plug 1, the shields 6 are so formed to extend in the radial direction of the spark plug 1 to shield the joining portions 53 of the corresponding ground electrodes 5 from directly facing outside of the spark plug 1 in the axial direction of the spark plug 1.

With such a formation, when the spark plug 1 is installed in the combustion chamber 72 of the engine, the joining portions 53 of the ground electrodes 5 will not be directly exposed to the high-speed and high-temperature combustion gases in the combustion chamber 72.

Consequently, it becomes possible to prevent the joining portions 53 of the ground electrodes 5 from cracking and vaporizing due to oxidization, thereby securing a reliable joining of the base portion 51 and tip portion 52 of each of the ground electrodes 5.

Further, in the spark plug 1, spark discharges are made between the tip portions 52 of the ground electrodes 5 and the corresponding side faces of the end portion 21 of the center electrode 2 in the radial direction of the spark plug 1.

Consequently, it becomes possible to suppress wear of the ground electrodes 5.

In the spark plug 1, the distance A is specified to be greater than or equal to zero. In other words, the joining portions 53 of the ground electrodes 5 are completely shielded from directly facing outside of the spark plug 1 in the axial direction of the spark plug 1.

Consequently, it becomes possible to more certainly secure a reliable joining of the base portion 51 and tip portion 52 of each of the ground electrodes 5.

In the spark plug 1, the distance a is specified to be greater than or equal to 0.3 mm. In other words, the tip portions 52 of the ground electrodes 5 are closer to the end portion 21 of the center electrode 2 in the radial direction of the spark plug 1 than the corresponding shields 6 0.3 mm or more.

Consequently, it becomes possible to permit the shields 6 not to hamper growth of the initial flame, thus securing the ignition capability (i.e., the capability to ignite the air/fuel mixture) of the spark plug 1.

Otherwise, if the distance a is less than 0.3 mm, the shields 6 may hamper growth of the initial flame, thus decreasing the ignition capability of the spark plug 1.

In the spark plug 1, the distance W is specified to be less than or equal to 2 mm.

Consequently, it becomes possible to more effectively prevent the joining portions 53 of the ground electrodes 5 from being directly exposed to the high-speed and high-temperature combustion gases in the combustion chamber 72, thereby more certainly securing a reliable joining of the base portion 51 and tip portion 52 of each of the ground electrodes 5.

Otherwise, if the distance W is greater than 2 mm, the combustion gases may flow into the gaps between the shields 6 and the corresponding ground electrodes 5, thus making it difficult to secure the strength of the joining portions 53 of the ground electrodes 5.

In the spark plug 1, the tip portions 52 of the ground electrodes 5 are made of a noble metal material, such as an Ir-based alloy and a Pt-based alloy.

Consequently, it becomes possible to secure durability of the ground electrodes 5.

On the other hand, the base portions 51 of the ground electrodes 5 and the shields 6 are made of a Ni-based alloy or steel.

Consequently, it becomes possible to make the spark plug 1 inexpensive.

In the spark plug 1, the metal shell 4 and the shields 6 are integrally formed.

Consequently, it becomes possible to reduce the number of parts of the spark plug 1, thus decreasing manufacturing cost of the spark plug 1.

The extension portion 42 of the metal shell 4, whose end portion 6 serves as the shields 6, have slits 61 formed therein without having the same angular positions as the joining portions 53 of the ground electrodes 5.

Consequently, it becomes possible to secure the space available for growth of the initial flame, thus improving the ignition capability of the spark plug 1.

Further, the width S of the slits 61 is specified to the range of 1 to 2 mm.

With such a specification, it becomes possible to secure a reliable joining of the base portion 51 and tip portion 52 of each of the ground electrodes 5 while securing the ignition capability of the spark plug 1.

Otherwise, if the width W is less than 1 mm, it may be difficult to secure a sufficient space available for growth of the initial flame, thus decreasing the ignition capability of the spark plug 1. On the contrary, if the width W is greater than 2 mm, the combustion gases may flow into the gaps between the shields 6 and the corresponding ground electrodes 5 through the slits 61, thus making it difficult to secure the strength of the joining portions 53 of the ground electrodes 5.

In the spark plug 1, there is provided more than one ground electrode 5.

With the increased number of ground electrodes 5, it becomes possible to decrease the frequency of spark discharges for each of the ground electrodes 5, thereby suppressing wear of the ground electrodes 5.

In the spark plug 1, the joining portion 53 of each of the ground electrodes 5 is shielded by a corresponding one of the separate shields 6.

Consequently, it becomes possible to more reliably secure the strength of the joining portions 53 of the ground electrodes 5 while securing the ignition capability of the spark plug 1.

The above-described ranges of the dimensional parameters A, S, and W have been determined through the experiments to be described below.

Experiment 1

This experiment was conducted to determine the effect of the distance A on the reliability of the joining portions 53 of the ground electrodes 5 in the spark plug 1.

It should be noted that in the present embodiment, the distance A takes a positive value in the case of the inner end face 62 of a shield 6 being closer to the center electrode 2 in the radial direction of the spark plug 1 than the inner end 531 of the joining portion 53 of the corresponding ground electrode 5 and a negative value in the opposite case.

In the experiment, the reliability of the joining portions 53 of the ground electrodes 5 was evaluated in terms of the strengths thereof before and after a durability test.

The durability test was conducted using a six-cylinder engine for a cogeneration system, under a test condition of 2000 hours continuous running at rated power.

Sample spark plugs having the same structure as the spark plug 1 were tested, in each of which the base portions 51 of the ground electrodes 5 were made of a Ni-base alloy, the tip portions 52 of the same were made of an Ir-based alloy, and the distance B, which represents the distance between the inner end 531 of the joining portion 53 and the inner end face 521 of the tip portion 52 in the radial direction as shown in FIG. 4, was 1.5 mm. However, the distance A was varied for those sample spark plugs.

The test results are shown in FIG. 5, where the plots of “●” indicate the strengths measured before the test and the plots of “◯” indicate the strengths measured after the test.

It can be seen from FIG. 5 that when the distance A was −0.2 mm or less, the strength was considerably decreased by the test. In comparison, when the distance A was 0 mm or more, the decrease in strength by the test was very small. Additionally, when the distance A was equal to −0.6 mm, the tip portions 52 were separated from the base portions 51 during the test.

Consequently, it was made clear from the experiment that the reliability of the joining portions 53 of the ground electrodes 5 in the spark plug 1 can be secured by specifying the distance A to be not less than zero, in other words, by configuring the shields 6 to completely shield the joining portions 53.

Experiment 2

This experiment was conducted to determine the effect of the width S of the slits 61 on the ignition capability of the spark plug 1.

In the experiment, the ignition capability of the spark plug 1 was evaluated in terms of standard deviation of BMEP (Brake Mean Effective Pressure). BMEP is the average effective pressure of the engine cylinders throughout the engine's operating cycle. A smaller standard deviation of BMEP means a higher combustion stability and a higher ignition capability.

Sample spark plugs having different widths S were tested using the same engine as used in the experiment 1. The engine was operated for 300 cycles, each of which includes four strokes of intake, compression, power, and exhaust. BMEP was determined for each cycle and the standard deviation of BMEP was calculated for the 300 cycles.

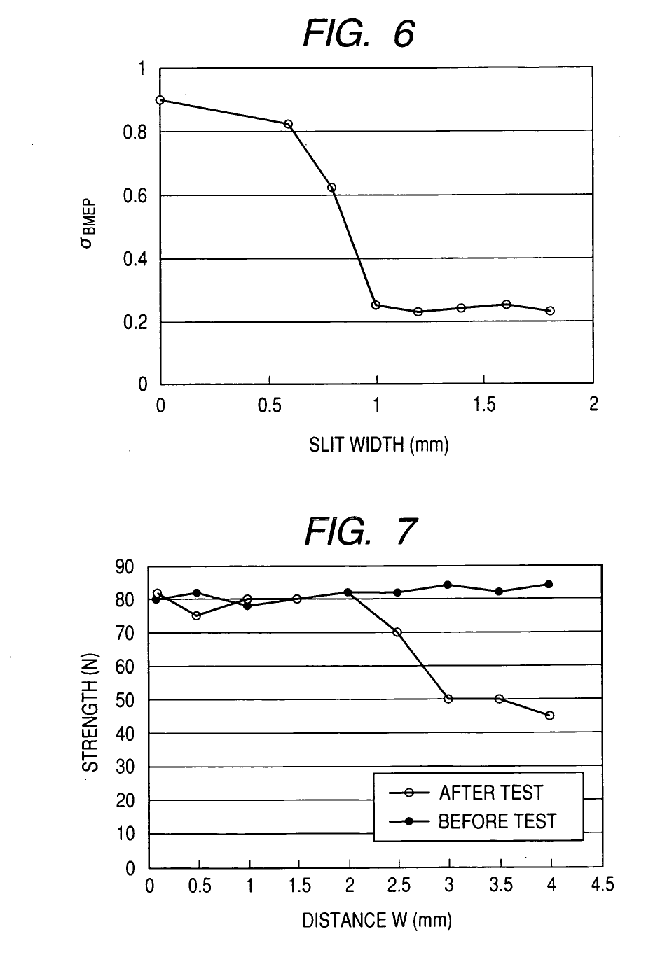

FIG. 6 shows the test results, where the horizontal axis represents the width S of the slits 61, while the vertical one represents the standard deviation of BMEP.

It can be seen from FIG. 6 that when the width S was 1 mm or more, the standard deviation of BMEP was considerably small.

Consequently, it was made clear from the experiment that the ignition capability of the spark plug 1 can be secured by specifying the width S of the slits 61 to be greater than or equal to 1 mm.

Experiment 3

This experiment was conducted to determine the effect of the distance W on the reliability of the joining portions 53 of the ground electrodes 5 in the spark plug 1.

Sample spark plugs having different distances W were fabricated for the experiment. For each of the sample spark plugs, the reliability of the joining portions 53 of the ground electrodes 5 was evaluated in the same way as in the experiment 1.

The results of the durability test for the sample spark plugs are shown in FIG. 7, where the plots of “●” indicate the strengths measured before the test and the plots of “0” indicate the strengths measured after the test.

It can be seen from FIG. 7 that when the distance W was less than or equal to 2 mm, the strength was kept from decreasing.

Consequently, it was made clear from the experiment that the reliability of the joining portions 53 of the ground electrodes 5 in the spark plug 1 can be secured by specifying the distance W to be not greater than 2 mm.

### Second Embodiment

This embodiment provides a spark plug 2 that has almost the same structure as the spark plug 1 according to the first embodiment. Accordingly, only the differences in structure therebetween will be described below.

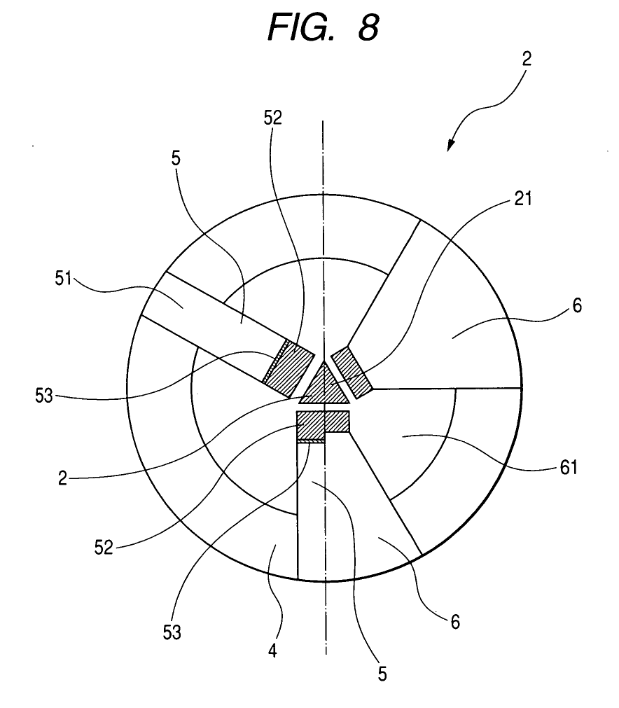

In the spark plug 2, as shown in FIG. 8, the number of ground electrodes 5 is three, instead of four as in the spark plug 1.

The end portion 21 of the center electrode 2 has the shape of a triangular prim, instead of a quadratic prism (i.e., a cuboid) as in the spark plug 1. Accordingly, the end portion 21 of the center electrode 2 has three side faces, each of which faces a corresponding one of the three ground electrodes 5 in the radial direction of the spark plug 1.

For each of the ground electrodes 5, the tip portion 52 is joined to the base portion 51 by resistance welding, instead of laser welding as in the spark plug 1.

The number of slits 61 formed in the extension portion 42 of the metal shell 4 is three, instead of four as in the spark plug 1. The slits 61 has, when viewed along the axial direction of the spark plug 1, the shape of a fan.

Accordingly, the number of separate shields 6 becomes three, instead of four as in the spark plug 1.

The spark plug 2 has the same advantages as the spark plug 1.

### Third Embodiment

This embodiment provides a spark plug 3 that has almost the same structure as the spark plug 1 according to the first embodiment. Accordingly, only the differences in structure therebetween will be described below.

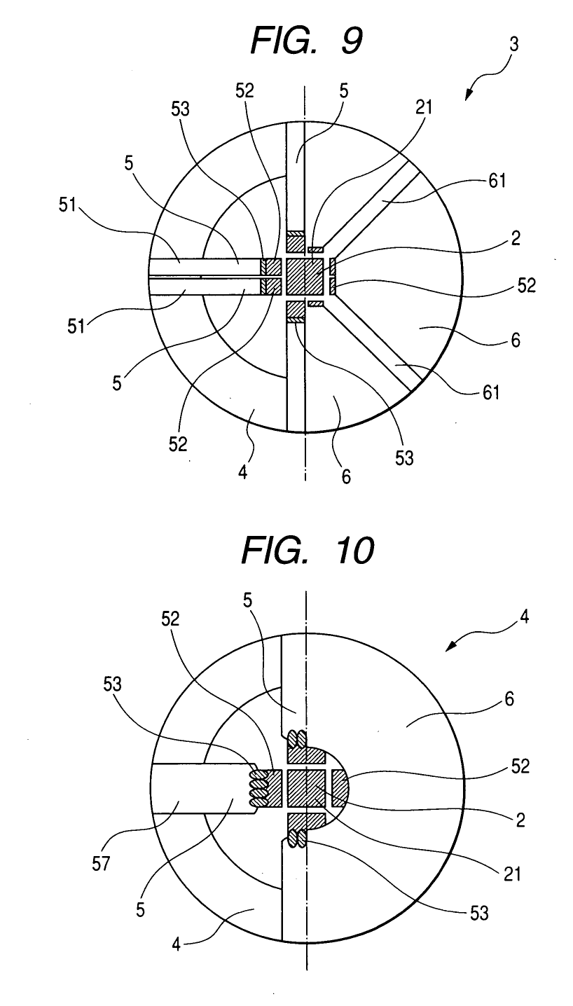

In the spark plug 3, as shown in FIG. 9, the number of ground electrodes 5 is eight, instead of four as in the spark plug 1.

Specifically, four pairs of the ground electrodes 5 are spaced evenly circumferentially around the center electrode 2. The tip portions 52 of each pair of the ground electrodes 5 face a common side face of the end portion 21 of the center electrode 2.

The joining portions 53 of each pair of the ground electrodes 5 are shielded by a common shield 6.

For each of the ground electrodes 5, the tip portion 52 is joined to the base portion 51 by resistance welding, instead of laser welding as in the spark plug 1.

The spark plug 2 has the same advantages as the spark plug 1.

### Fourth Embodiment

This embodiment provides a spark plug 4 that has almost the same structure as the spark plug 1 according to the first embodiment. Accordingly, only the differences in structure therebetween will be described below.

In the spark plug 4, as shown in FIG. 10, there is no slit 61 formed in the extension portion 42 of the metal shell 4. Accordingly, the joining portions 53 of the ground electrodes 5 are shielded by the single shield 6, instead of the four separate shields 6 as in the spark plug 1.

The spark plug 4 has almost the same advantages as the spark plug 1.

### Fifth Embodiment

This embodiment provides a spark plug 5 that has almost the same structure as the spark plug 1 according to the first embodiment. Accordingly, only the differences in structure therebetween will be described below.

In the spark plug 5, as shown in FIG. 11, the end portion 21 of the center electrode 2 has the shape of a cylinder, instead of a cuboid as in the spark plug 1.

The tip portion 52 of each of the ground electrodes 5 has the inner end face 521 that is outwardly recessed along the circumference of the end portion 21 of the center electrode 2 with the spark gap formed therebetween.

In addition, for each of the ground electrodes 5, the tip portion 52 is joined to the base portion 51 by resistance welding, instead of laser welding as in the spark plug 1.

The spark plug 5 has the same advantages as the spark plug 1.

### Sixth Embodiment

This embodiment provides a spark plug 6 that has almost the same structure as the spark plug 1 according to the first embodiment. Accordingly, only the differences in structure therebetween will be described below.

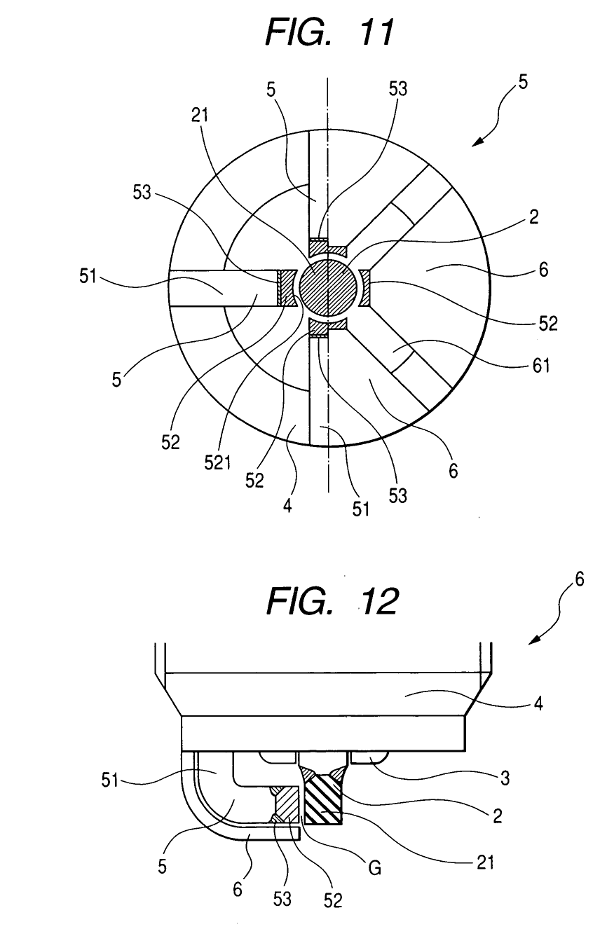

In the spark plug 6, as shown in FIG. 12, the ground electrode 5 and the shield 6 are formed separately with respect to the metal shell 4, instead of integrally as in the spark plug 1.

The base portion 51 of the ground electrode 5 is bent to have an L-shape with a base end joined to the metal shell 4 and a tip end to which the tip portion 52 of the ground electrode 5 is joined by laser welding.

The shield 6 is also joined to the metal shell 4 and bent to have an L-shape at the outside of the ground electrode 5, so that a portion thereof extends in the radial direction of the spark plug 6 along the outer side surface of the ground electrode 5 with a gap formed therebetween. The size of the gap between the shield 6 and the tip portion 52 of the ground electrode 5 in the axial direction of the spark plug 6 is 2 mm or less.

In addition, though only a pair of the ground electrode 5 and the shield 6 is illustrated in FIG. 12, the spark plug 6 may also be configured to include more than one pair of the ground electrode 5 and the shield 6.

The spark plug 6 has the same advantages as the spark plug 1.

### Seventh Embodiment

This embodiment provides a spark plug 7 that has almost the same structure as the spark plug 6 according to the sixth embodiment. Accordingly, only the differences in structure therebetween will be described below.

In the spark plug 7, as shown in FIG. 13, the shield 6 is formed integrally with the ground electrode 5, instead of separately as in the spark plug 6.

Specifically, the base portion 51 of the ground electrode 5 has an end portion 511 that is partially cut off on the axially outer side. The tip portion 52 is disposed to fill the vacancy in the end portion 511 of the base portion 51 and the joining portion 53 is formed between the tip portion 52 and the remaining part of the end portion 511 of the base portion 51.

Consequently, the joining portion 53 is shielded by the tip portion 52 from directly facing outside of the spark plug 7 in the axial direction. In other words, in the spark plug 7, the tip portion 52 of the ground electrode 5 is configured to serve as the shield 6.

With such a configuration, compared to the spark plug 6, the spark plug 7 has a further advantage of allowing the number of parts and thus manufacturing cost to be reduced.

In addition, though only the single ground electrode 5 is illustrated in FIG. 13, the spark plug 7 may also be configured to include more than one the ground electrode 5.

### Eighth Embodiment

This embodiment provides a spark plug 8 that has almost the same structure as the spark plug 7 according to the seventh embodiment. Accordingly, only the differences in structure therebetween will be described below.

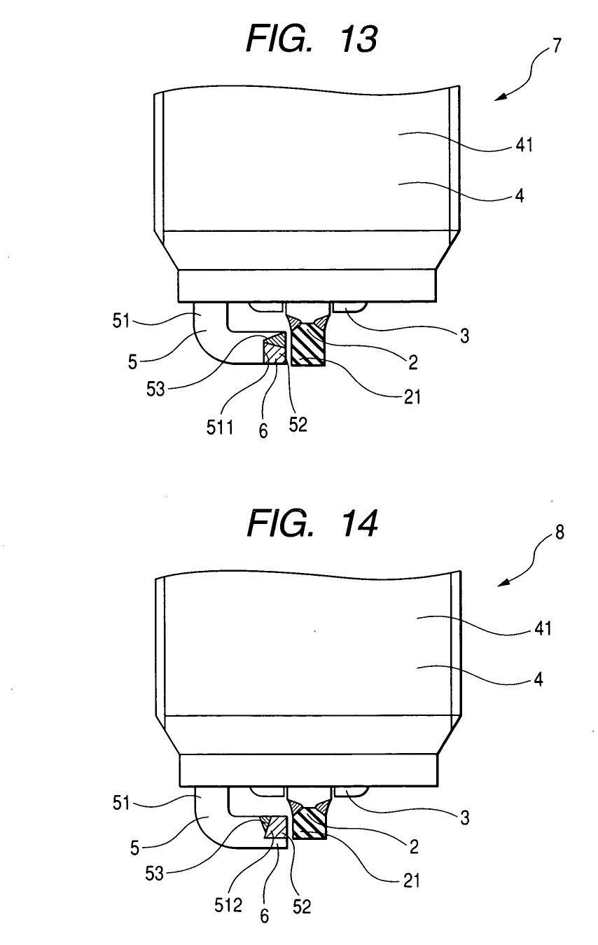

In the spark plug 8, as shown in FIG. 14, the base portion 51 of the ground electrode 5 serves as the shield 6, instead of the tip portion 52 as in the spark plug 7.

Specifically, in the spark plug 8, the base portion 51 of the ground electrode 5 has an end portion 512 that is partially cut off on the axially inner side. The tip portion 52 and the joining portion 53 are arranged to fill the vacancy in the end portion 512 of the base portion 51, so that the joining portion 53 is shielded by the remaining part of the end portion 512 of the base portion 51 from directly facing outside of the spark plug 8 in the axial direction. In other words, in the spark plug 8, the base portion 51 of the ground electrode 5 is configured to serve as the shield 6.

In addition, though only the single ground electrode 5 is illustrated in FIG. 14, the spark plug 8 may also be configured to include more than one the ground electrode 5.

The spark plug 8 has the same advantages as the spark plug 7.

### Ninth Embodiment

This embodiment provides a spark plug 9 that has almost the same structure as the spark plug 8 according to the eighth embodiment. Accordingly, only the differences in structure therebetween will be described below.

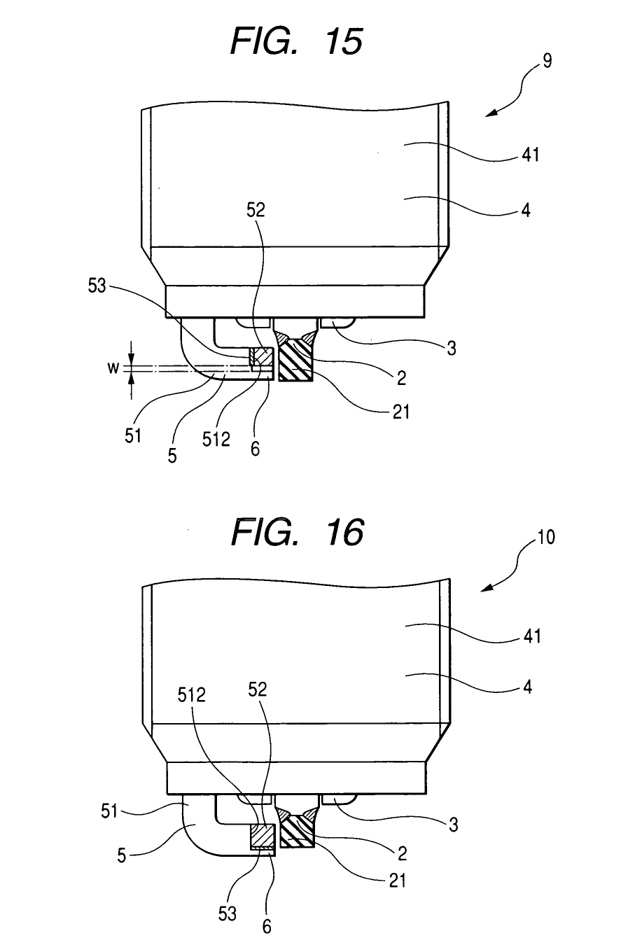

In the spark plug 9, with reference to FIG. 15, the base portion 51 of the ground electrode 5 serves as the shield 6 as in the spark plug 7.

However, in the spark plug 9, there is a gap formed between the remaining part of the end portion 512 of the base portion 51, which serves as the shield 6, and the tip portion 52. The size of the gap in the axial direction of the spark plug 9 is 2 mm or less.

In addition, though only the single ground electrode 5 is illustrated in FIG. 15, the spark plug 9 may also be configured to include more than one the ground electrode 5.

The spark plug 9 has the same advantages as the spark plug 8.

### Tenth Embodiment

This embodiment provides a spark plug 10 that has almost the same structure as the spark plug 8 according to the eighth embodiment. Accordingly, only the differences in structure therebetween will be described below.

In the spark plug 10, with reference to FIG. 16, the remaining part of the end portion 512 of the base portion 51 serves as the shield 6 as in the spark plug 8.

However, in the spark plug 10, the tip portion 52 is joined to the remaining part of the end portion 512 of the base portion 51 through the joining portion 53. Consequently, the base portion 51, the joining portion 53, and the tip portion 52 are serially arranged in the axial direction of the spark plug 10, instead of in the radial direction as in the spark plug 8.

In addition, though only the single ground electrode 5 is illustrated in FIG. 16, the spark plug 10 may also be configured to include more than one the ground electrode 5.

The spark plug 10 has the same advantages as the spark plug 8.

### Eleventh Embodiment

This embodiment provides a spark plug 11 that has almost the same structure as the spark plugs 1-10 according to the previous embodiments. Accordingly, only the differences in structure therebetween will be described below.

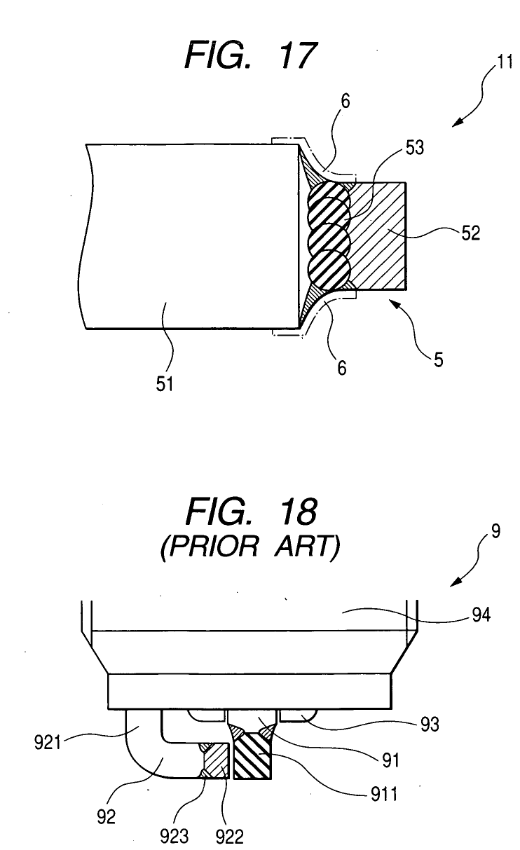

In the spark plug 11, as shown in FIG. 17, the surface of the joining portion 53 of the ground electrode 5 is covered by a coating layer 6. In other words, the coating layer 6 composes the shield 6 to shield the joining portion 53 of the ground electrode 5 from directly facing outside of the spark plug 11 in the axial direction of the spark plug 11. The coating layer 6 is formed by, for example, plating or thermal spraying.

It is preferable that the coating layer 6 covers the entire circumference of the joining portion 53 of the ground electrode 5, so that it can completely shield the joining portion 53 from exposure to the combustion gases in the combustion 72.

It is also preferable that the coating layer 6 (i.e., the shield 6) is made of a ceramic material, so that heat transfer from the combustion gases in the combustion chamber 72 to the joining portion 53 can be suppressed, thereby more effectively preventing oxidization of the joining portion 53.

While the above particular embodiments of the invention have been shown and described, it will be understood by those who practice the invention and those skilled in the art that various modifications, changes, and improvements may be made to the invention without departing from the spirit of the disclosed concept.

Such modifications, changes, and improvements within the skill of the art are intended to be covered by the appended claims.

What is claimed is:

1. A spark plug for an internal combustion engine comprising:
a tubular metal shell;
an insulator retained in said metal shell;
a center electrode secured in said insulator such that an end portion of said center electrode protrudes out of said insulator;
a ground electrode including a base portion, a tip portion, and a joining portion that joins together the base and tip portions, the base portion being fixed to said metal shell, the tip portion facing a side surface of the end portion of said center electrode through a spark gap in a direction perpendicular to a longitudinal direction of the spark plug; and
a shield shielding the joining portion of said ground electrode from directly facing outside of the spark plug in the longitudinal direction of the spark plug.

2. The spark plug as set forth in claim 1, wherein said shield is so formed to have at least a portion thereof extending in the direction perpendicular to the longitudinal direction of the spark plug, by which the joining portion of said ground electrode is completely shielded from directly facing outside of the spark plug in the longitudinal direction of the spark plug.

3. The spark plug as set forth in claim 2, wherein the tip portion of said ground electrode is closer to the end portion of said center electrode in the direction perpendicular to the longitudinal direction of the spark plug than said shield 0.3 mm or more.

4. The spark plug as set forth in claim 2, wherein a distance between said shield and the tip portion of said ground electrode in the longitudinal direction of the spark plug is 2 mm or less.

5. The spark plug as set forth in claim 2, wherein said shield is integrally formed with said metal shell, and wherein said metal shell has an inner chamber, in which said ground electrode is mounted, and an end portion that serves as said shield.

6. The spark plug as set forth in claim 5, wherein a slit is formed in the end portion of said metal shell without having the same angular position as the joining portion of said ground electrode.

7. The spark plug as set forth in claim 6, wherein the slit has a width in the range of 1 to 2 mm.

8. The spark plug as set forth in claim 2, wherein said shield and said ground electrode are separately formed and fixed to said metal shell.

9. The spark plug as set forth in claim 2, wherein said shield is integrally formed with said ground electrode.

10. The spark plug as set forth in claim 9, wherein the tip portion of said ground electrode serves as said shield.

11. The spark plug as set forth in claim 9, wherein the base portion of said ground electrode serves as said shield.

12. The spark plug as set forth in claim 11, wherein the base portion, joining portion, and tip portion of said ground electrode are serially arranged in the direction perpendicular to the longitudinal direction of the spark plug.

13. The spark plug as set forth in claim 11, wherein the base portion, joining portion, and tip portion of said ground electrode are serially arranged in the longitudinal direction of the spark plug.

14. The spark plug as set forth in claim 2, wherein said shield is made of one of a Ni-based alloy and steel.

15. The spark plug as set forth in claim 1, wherein said shield is composed of a coating layer that covers a surface of the joining portion of said ground electrode.

16. The spark plug as set forth in claim 15, wherein the coating layer covers the surface of the joining portion of said ground electrode over an entire circumference of the joining portion.

17. The spark plug as set forth in claim 15, wherein the coating layer is made of a ceramic material.

18. The spark plug as set forth in claim 1 further comprising a plurality of said ground electrodes, wherein the joining portions of all said ground electrodes are shielded by a single said shield.

19. The spark plug as set forth in claim 1 further comprising a plurality of said ground electrodes and a plurality of said shields, wherein the joining portion of each of all said ground electrodes is shielded by a corresponding one of all said shields.

20. The spark plug as set forth in claim 1, wherein the tip portion of said ground electrode is made of one of an Ir-based alloy and a Pt-based alloy.

21. The spark plug as set forth in claim 1, wherein the base portion of said ground electrode is made of one of a Ni-based alloy and steel.

22. The spark plug as set forth in claim 1, wherein the joining portion of said ground electrode is a weld formed by laser welding of the tip portion to the base portion of said ground electrode.

23. The spark plug as set forth in claim 1, wherein the joining portion of said ground electrode is a weld formed by resistance welding of the tip portion to the base portion of said ground electrode.

24. The spark plug as set forth in claim 1, wherein the end portion of said center electrode has a prismatic shape and the tip portion of said ground electrode has a flat end face facing the side surface of the end portion of said center electrode through the spark gap.

25. The spark plug as set forth in claim 1, wherein the end portion of said center electrode has a cylindrical shape and the tip portion of said ground electrode has an end face that is recessed outwardly along the side surface of the end portion of said center electrode with the spark gap formed therebetween.
